(19) United States
(12) Patent Application Publication
(10) Pub. No.: US 2025/0172128 A1
(43) Pub. Date: May 29, 2025

(54) METHOD FOR REMOVING SCALE IN GEOTHERMAL POWER PLANT

(71) Applicant: FUJI ELECTRIC CO., LTD., Kanagawa (JP)

(72) Inventors: Akitoshi HARUYAMA, Tokyo (JP); Shinya UI, Tokyo (JP); Azusa OZAWA, Tokyo (JP); Tianlong JIANG, Tokyo (JP); Yukari SHIBUTA, Tokyo (JP)

(21) Appl. No.: 19/041,338

(22) Filed: Jan. 30, 2025

Related U.S. Application Data
(63) Continuation of application No. PCT/JP2024/003356, filed on Feb. 1, 2024.

(30) Foreign Application Priority Data
Feb. 16, 2023 (JP) 2023-022943

(51) Int. Cl. F03G 4/00; C02F 5/08

(52) U.S. Cl. CPC F03G 4/069; C02F 5/083

(57) ABSTRACT

A method for removing scale that is precipitated from geothermal fluid containing dissolved silica and becomes adherent in a geothermal power plant including: a water supply pump for pumping the geothermal fluid from a production well; a gas-water separator for separating the geothermal fluid into geothermal water and geothermal steam; and a turbine for rotating by being supplied with the geothermal steam separated by the gas-water separator includes: forming a surface of a location in the geothermal power plant contacted by the geothermal fluid from diamond-like carbon in a first region extending from the production well to the turbine; forming at least the surface of the location in the geothermal power plant from at least one selected from diamond-like carbon, polytetrafluoroethylene, and polyvinyl chloride in a region other than the first region; and injecting a scale removing liquid into a flow path including the surface of the location.

### CROSS-REFERENCE TO RELATED APPLICATIONS

This application is a continuation application of International Application No. PCT/JP2024/003356, filed on Feb. 1, 2024, and designating the U.S., which is based upon and claims priority to Japanese Patent Application No. 2023-022943, filed on Feb. 16, 2023, the entire contents of which are incorporated herein by reference.

### BACKGROUND

### Technical Field

The present invention relates to a method for removing scale in a geothermal power plant.

### Background Art

In geothermal power generation, high-temperature geothermal fluid (geothermal water and geothermal steam) is collected from a production well, and power generation is performed utilizing steam separated from the geothermal fluid. The geothermal fluid collected from the production well contains more dissolved silica than does well water or river water.

In a geothermal power plant, dissolved silica in geothermal water collected from a production well is concentrated by depressurization, and is cooled while flowing through piping, resulting in reduction in the solubility. Then, when the silica contained in the geothermal water becomes supersaturated, it polymerizes to form amorphous silica and precipitates as silica scale. Because silica scale adheres to the inner wall of piping and the like and may cause clogging of the piping and the like, adhesion of silica scale is a problem in geothermal power plants.

There is a known method of injecting an oxidizing agent such as hydrochloric acid, sulfuric acid, nitric acid, hydrofluoric acid, or the like, or an alkaline agent such as sodium hydroxide, sodium carbonate, sodium hydrogen carbonate, or the like into the piping or the like to which silica scale adheres, as a chemical agent for dissolving and cleaning the silica scale. For example, Japanese Patent Application Laid-Open Publication No. 2013-202424 discloses a method of removing scale by bringing a scale removing solution containing tropones and an acid such as hydrochloric acid, sulfuric acid, nitric acid, or the like into contact with the scale.

### SUMMARY

However, even if the chemical agent is brought into contact with the scale, the existing scale removing method may have difficulty delivering the chemical agent to the surface to which the scale adheres, especially at a position where the thickness of the scale is large, and may cause a cleaning failure due to the scale remaining on the inner wall or the like of the piping.

An embodiment of the present invention provides a scale removing method capable of avoiding a scale cleaning failure.

An embodiment of the present invention is a method for removing scale that is precipitated from geothermal fluid containing dissolved silica and becomes adherent in a geothermal power plant including: a water supply pump configured to pump the geothermal fluid from a production well; a gas-water separator configured to separate the geothermal fluid into geothermal water and geothermal steam; and a turbine configured to rotate by being supplied with the geothermal steam separated by the gas-water separator, with the water supply pump, the gas-water separator, and the turbine being situated in order from an upstream side of the geothermal fluid, the method including: forming a surface of a location in the geothermal power plant, the location being contacted by the geothermal fluid, from diamond-like carbon in a first region extending from the production well to the turbine; forming at least the surface of the location in the geothermal power plant from at least one selected from diamond-like carbon, polytetrafluoroethylene, and polyvinyl chloride in a region other than the first region; and injecting a scale removing liquid into a flow path including the surface of the location.

According to one embodiment of the present invention, it is possible to avoid a scale cleaning failure.

### BRIEF DESCRIPTION OF THE DRAWINGS

FIG. 1 is a schematic configuration diagram of a geothermal power plant according to an embodiment;

FIG. 2 is a graph illustrating the amount of silica scale adhering to each material piece;

FIG. 3 is a SEM observation image illustrating a surface of a material piece made of PVC; and

FIG. 4 is a SEM observation image illustrating a surface of a material piece made of 13% Cr steel.

### DETAILED DESCRIPTION OF THE INVENTION

Hereinafter, an embodiment for carrying out the present invention will be described with reference to the drawings.

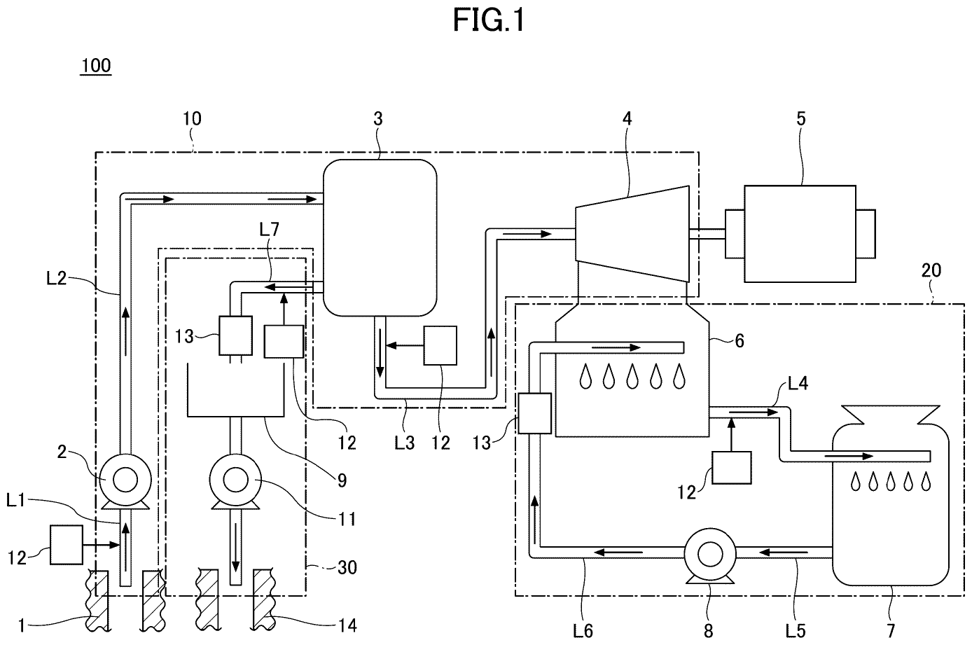

FIG. 1 is a schematic configuration diagram of a geothermal power plant according to an embodiment. As illustrated in FIG. 1, a geothermal power plant 100 includes a water supply pump 2 configured to pump geothermal fluid from a production well 1, a gas-water separator 3 configured to separate the geothermal fluid into geothermal water and geothermal steam, and a turbine 4 configured to rotate by being supplied with the geothermal steam separated by the gas-water separator 3, which are situated in the stated order from the upstream side of the geothermal fluid. In the geothermal power plant 100, a region extending from the production well 1 to the turbine 4 as described above is referred to as a first region 10. That is, the first region 10 includes the production well 1, the water supply pump 2, the gas-water separator 3, and the turbine 4. The turbine 4 is connected to a power generator 5. The first region is a region in the geothermal power plant 100 that is in a high-temperature high-pressure environment.

The geothermal power plant 100 may include a pipe L1 for introducing geothermal fluid (geothermal water and geothermal steam) pumped from the production well 1 into the water supply pump 2, a pipe L2 for introducing the geothermal fluid discharged from the water supply pump 2 into the gas-water separator 3, and a pipe L3 for introducing the geothermal steam separated by the gas-water separator 3 into the turbine 4. That is, the first region 10 may include the pipes L1 to L3.

The geothermal power plant 100 may include a condenser 6 for condensing geothermal steam discharged from the turbine 4, a cooling tower 7 for cooling the condensed water condensed by the condenser 6, and a circulation pump 8 for sending cooling water cooled by the cooling tower 7 to the condenser 6. In the geothermal power plant 100, a region from the condenser 6 and back to the condenser 6, through which condensed water is returned while being cooled, is referred to as a second region 20. That is, the second region 20 may include the condenser 6, the cooling tower 7, and the circulation pump 8. The second region is a region in the geothermal power plant 100 that is in a low-temperature low-pressure environment.

The geothermal power plant 100 may include a pipe L4 for introducing condensed water (hot water) condensed by the condenser 6 into the cooling tower 7, a pipe L5 for introducing the cooling water cooled by the cooling tower 7 into the circulation pump 8, and a pipe L6 for returning the cooling water discharged from the circulation pump 8 to the condenser 6. That is, the second region 20 may include the pipes L4 to L6.

The geothermal power plant 100 may include a retention tank 9 situated on a flow path through which geothermal water separated by the gas-water separator 3 flows, and a reduction pump 11 for returning the geothermal water discharged from the retention tank 9 to a reduction well 14. The retention tank 9 promotes polymerization reaction of silica in the geothermal water, and retains the geothermal water until a silica-based insoluble component sufficiently flocculates and precipitates. In the geothermal power plant 100, a region extending from the outlet of the gas-water separator 3 from which the geothermal water flows out to the reduction well 14 is referred to as a third region 30. That is, the third region 30 may include the retention tank 9, the reduction pump 11, and the reduction well 14. The third region is a region in the geothermal power plant 100 that is in a high-temperature medium-pressure or medium-temperature high-pressure environment.

The geothermal power plant 100 may include a pipe L7 for introducing the geothermal water separated by the gas-water separator 3 into the retention tank 9. That is, the third region 30 may include the pipe L7.

Next, the flow of geothermal fluid in the geothermal power plant 100 will be described. In FIG. 1, the flow of geothermal fluid is indicated by solid arrows in each pipe. The production well 1 is a well that draws geothermal water, geothermal steam, or a mixture of these (geothermal fluid) from an underground geothermal reservoir to the ground. The geothermal fluid pumped from the production well 1 is introduced into the water supply pump 2 through the pipe L1 and sent to the gas-water separator 3 through the pipe L2. The gas-water separator 3 separates geothermal steam as a gaseous component and geothermal water as a liquid component. The separated geothermal steam is sent to the turbine 4 through the pipe L3 and used to rotate the turbine 4 for power generation by the power generator 5.

The geothermal steam that has passed through the turbine 4 is sent to the condenser 6 to be condensed, and condensed water resulting from the condensation is further sent to the cooling tower 7 through the pipe L4 to be cooled. The cooled cooling water is introduced into the circulation pump 8 through the pipe L5, returned to the condenser 6 through the pipe L6, and used as cooling water for the geothermal steam that has passed through the turbine 4.

The geothermal fluid contains dissolved silica. The method for the geothermal power plant 100 to remove scale (silica scale or amorphous silica) that is precipitated from geothermal fluid and becomes adherent includes: forming a surface of a location in the geothermal power plant 100, the location being contacted by the geothermal fluid, from diamond-like carbon in the first region 10; forming at least the surface of the location in the geothermal power plant 100 that is contacted by the geothermal fluid from at least one selected from diamond-like carbon, polytetrafluoroethylene, and polyvinyl chloride in a region other than the first region; and injecting a scale removing liquid into a flow path including the surface of the location contacted by the geothermal fluid.

In general, the location in the geothermal power plant that is contacted by geothermal fluid such as the piping, the turbine, and the like is formed of a steel material. Since hydroxyl groups on the surface of the steel material and silica easily bond with each other, silica scale readily adheres to the location contacted by the geothermal fluid. Therefore, the present inventor has focused on the fact that hydroxyl groups that easily bond with silica are scarcer on the surface of diamond-like carbon materials, polytetrafluoroethylene materials, and polyvinyl chloride materials than on the surface of steel materials, and that in particular, hydroxyl groups are even scarcer on the surface of diamond-like carbon materials. In the present embodiment, by forming the surface of the location contacted by geothermal fluid from diamond-like carbon in the first region of the geothermal power plant 100 where the dissolved silica concentration is high, it is possible to effectively reduce the starting point of silica scale adhesion on the surface of the location contacted by the geothermal fluid, and to reduce the bonding force between the surface and the silica scale. By forming at least the surface of the location contacted by the geothermal fluid from at least one selected from diamond-like carbon, polytetrafluoroethylene, and polyvinyl chloride in a region other than the first region, it is possible to reduce the bonding force between the surface of the location contacted by the geothermal fluid and the silica scale. Therefore, by injecting a scale removing liquid into the flow path including the surface of the location contacted by the geothermal fluid, it is possible to easily peel, dissolve, and remove the silica scale, and to avoid a scale cleaning failure.

Further, in the first region of the geothermal power plant 100 that is in a high-temperature high-pressure environment, by forming the surface of the location contacted by the geothermal fluid from diamond-like carbon having excellent heat resistance and excellent pressure resistance, it is possible to inhibit deterioration or change of the surface of the location contacted by the geothermal fluid, and to reduce the bonding force between the surface and the silica scale. In a region other than the first region, by forming at least the surface of the location contacted by the geothermal fluid from at least one selected from diamond-like carbon, polytetrafluoroethylene, and polyvinyl chloride, it is possible to inhibit deterioration or change of the surface of the location contacted by the geothermal fluid, and to reduce the bonding force between the surface and the silica scale.

Specifically, examples of the surface of the location in the geothermal power plant 100 contacted by the geothermal fluid include the inner circumferential surfaces of the pipes L1 to L7 and the outer circumferential surface of the turbine 4. That is, the method for removing scale in the geothermal power plant 100 may include forming the inner circumferential surfaces of the pipes L1 to L3 and the outer circumferential surface of the turbine 4 in the first region 10 from diamond-like carbon, forming at least the inner circumferential surfaces of the pipes L4 to L7 in the second region and the third region from at least one selected from diamond-like carbon, polytetrafluoroethylene, and polyvinyl chloride, and injecting a scale removing liquid into flow paths including the inner circumferential surfaces of the pipes L1 to L7 and the outer circumferential surface of the turbine 4.

According to the method for removing scale in the geothermal power plant 100, in a case where the material used for the pipes L4 to L7 is polytetrafluoroethylene or polyvinyl chloride, it is preferable to form the pipes L4 to L7 in the second region and the third region from polytetrafluoroethylene or polyvinyl chloride. In general, in a pipe provided with a coating layer made of a resin material on the inner circumferential surface, the coating layer may be peeled to expose a base material such as a steel material, and the bonding force between the inner circumferential surface of the pipe and the silica scale may be increased. According to the method for removing scale in this embodiment, since an entire pipe is made of polytetrafluoroethylene or polyvinyl chloride, the bonding force between the inner circumferential surface of the pipe and the silica scale can be suppressed even when the inner circumferential surface of the pipe is peeled or damaged. Therefore, by injecting the scale removing liquid into the flow path including the surface of the location contacted by the geothermal fluid, it is possible to more easily peel, dissolve, and remove the silica scale, to better avoid a scale cleaning failure.

The scale removing liquid may be an acid or an alkali. When the scale removing liquid is an acid or an alkali, the silica scale can be more easily peeled, dissolved, and removed, and a scale cleaning failure can be better avoided.

The acid is not particularly limited, and examples of the acid include organic acids such as formic acid, oxalic acid, acetic acid, and the like, or inorganic acids such as hydrochloric acid, sulfuric acid, nitric acid, and the like. The alkali is not particularly limited, and examples of the alkali include hydroxides such as sodium hydroxide, potassium hydroxide, and the like, carbonate compounds such as sodium carbonate and the like, hydrogen carbonate compounds such as sodium hydrogen carbonate, potassium hydrogen carbonate, and the like, sodium acetate, potassium acetate, ammonia, organic amines, and the like. Among these, the scale removing liquid preferably contains at least one selected from hydrochloric acid, sulfuric acid, hydroxide, carbonate compounds, hydrogen carbonate compounds, and salts thereof. Thus, it is possible to inhibit the surface, of the location contacted by the geothermal fluid, that is formed from diamond-like carbon, polytetrafluoroethylene, or polyvinyl chloride from being dissolved or changed by the scale removing liquid and the bonding force between the surface of the location and the silica scale from being increased. Therefore, by injecting the scale removing liquid into the flow path including the surface of the location contacted by the geothermal fluid, it is possible to more easily peel, dissolve, and remove the silica scale, and to better avoid a scale cleaning failure.

According to the method for removing scale in the geothermal power plant 100, when the geothermal fluid is geothermal steam, it is possible to spray-feed the scale removing liquid into the geothermal stream and mix it with the geothermal steam at the location contacted by the geothermal steam. More specifically, for example, it is possible to spray-feed and mix the scale removing liquid with the geothermal steam at the pipe L3 and the turbine 4 in the first region 10. Thus, with the flow of the geothermal steam, the scale removing liquid can be diffused and brought into contact with the entirety of the location contacted by the geothermal steam. Thus, it is possible to more easily peel, dissolve, and remove the silica scale, and to better avoid a scale cleaning failure.

According to the method for removing scale in the geothermal power plant 100, when the geothermal fluid is geothermal water, it is possible to supply the scale removing liquid into the geothermal water and mix it with the geothermal water at the location contacted by the geothermal water. More specifically, for example, it is possible to supply and mix the scale removing liquid with the geothermal water at the pipes L1 and L2 of the first region 10, the pipes L4 to L6 of the second region, and the pipe L7 of the third region. Thus, with the flow of the geothermal water, the scale removing liquid can be diffused and brought into contact with the entirety of the location contacted by the geothermal water. Therefore, it is possible to more easily peel, dissolve, and remove the silica scale, and to better avoid a scale cleaning failure.

According to the method for removing scale in the geothermal power plant 100, the scale removing liquid may be supplied to the geothermal fluid flowing through the flow path while the geothermal power plant 100 is operating, and the flow path may be left to stand still while being filled with the scale removing liquid or geothermal water mixed with the scale removing liquid while the geothermal power plant 100 is stopped. Thus, it is possible to perform the scale removing work while operating the geothermal power plant 100. At the same time, while the geothermal power plant 100 is stopped, it is possible to perform the scale removing work intensively for cases where there is scale that cannot be completely removed during operation. Therefore, it is possible to more easily peel, dissolve, and remove scale, and to better avoid a scale cleaning failure.

According to the method for removing scale in the geothermal power plant 100, while the geothermal power plant 100 is operating, it is preferable to inject the scale removing liquid into at least one flow path among the flow path between the production well 1 and the water supply pump 2, the flow path between the gas-water separator 3 and the turbine 4, the flow path between the condenser 6 and the cooling tower 7, and the flow path between the gas-water separator 3 and the retention tank 9. As a result, it is possible to inject the scale removing liquid into the flow paths where the temperature readily lowers and silica scale readily occurs, and to better avoid a scale cleaning failure.

According to the method for removing scale in the geothermal power plant 100, while the geothermal power plant 100 is operating, the scale removing liquid may be injected into the most upstream flow path in each of the first region 10, the second region 20, and the third region 30. As a result, it is possible to even better avoid a scale cleaning failure.

According to the method for removing scale in the geothermal power plant 100, while the geothermal power plant 100 is operating, it is more preferable to inject the scale removing liquid into at least the flow path between the production well 1 and the water supply pump 2 and the flow path between the gas-water separator 3 and the retention tank 9. As a result, it is possible to even better avoid a scale cleaning failure.

An example of the configuration for injecting the scale removing liquid into each of the above-described flow paths will be described. As illustrated in FIG. 1, the geothermal power plant 100 may include a scale removing liquid tank 12 connected to each of the pipe L1 constituting the flow path between the production well 1 and the water supply pump 2, the pipe L3 constituting the flow path between the gas-water separator 3 and the turbine 4, the pipe L4 constituting the flow path between the condenser 6 and the cooling tower 7, and the pipe L7 constituting the flow path between the gas-water separator 3 and the retention tank 9. The scale removing liquid tanks 12 are connected to the pipes L1, L3, L4, and L7 via pumps (not illustrated), respectively. It is preferable that the scale removing liquid tanks 12 are situated on a more upstream side of each of the pipes L1, L3, L4, and L7.

According to the method for removing scale in the geothermal power plant 100, the scale removed by the scale removing liquid may be collected on the downstream side of a position at which the scale removing liquid is supplied into the geothermal fluid. As a result, scale fragments peeled from the surface of the location contacted by the geothermal fluid such as the inner circumferential surface of the pipes and floating in the geothermal fluid can be captured and collected. This makes it possible to better avoid a scale cleaning failure.

According to the method for removing scale in the geothermal power plant 100, it is preferable to collect scale in the flow path between the gas-water separator 3 and the retention tank 9. As a result, it is possible to effectively collect scale in the flow path where the temperature readily lowers and silica scale readily occurs, and to better avoid a scale cleaning failure. Furthermore, scale may be collected in the flow path between the circulation pump 8 and the condenser 6.

An example of the configuration for scale collection described above will be described. As illustrated in FIG. 1, the geothermal power plant 100 may include a collector 13 connected to the pipe L7 constituting the flow path between the gas-water separator 3 and the retention tank 9. The collector 13 may be, for example, a container having a wire mesh inside for capturing scale fragments or a container having the same function as the retention tank 9. The geothermal power plant 100 may further include a collector 13 connected to the pipe L6 constituting the flow path between the circulation pump 8 and the condenser 6.

According to the method for removing scale in the geothermal power plant 100, the supply flow rate or the concentration of the scale removing liquid may be controlled in accordance with the mass of the collected scale. Thus, the cleaning power can be adjusted in accordance with the amount of scale generation, and a scale cleaning failure can be better avoided. The geothermal power plant 100 may include a mass meter for measuring the mass of collected scale, a flow meter for detecting the supply flow rate of the scale removing liquid, and a controller for controlling the supply flow rate or the concentration of the scale removing liquid. The controller determines the supply flow rate or the concentration of the scale removing liquid based on the mass obtained from the mass meter. In a case of determining the concentration of the scale removing liquid, the controller calculates the supply flow rate of the scale removing liquid based on the determined concentration and the flow rate of the geothermal fluid. The controller then operates the pump (not illustrated) connected to the scale removing liquid tank 12 so as to attain the determined supply flow rate or concentration.

According to the method for removing scale in the geothermal power plant 100, before the scale removing liquid is supplied to geothermal fluid flowing through a flow path, a scale release agent may be supplied to the geothermal fluid in advance. The scale release agent arrives at the surface of the location in the geothermal power plant 100 contacted by the geothermal fluid, and can better reduce the bonding force between the surface of the location and silica scale. Therefore, by injecting the scale removing liquid into the flow path including the surface of the location after better reducing the bonding force between the surface of the location and silica scale, it is possible to more easily peel, dissolve, and remove the silica scale, and to better avoid a scale cleaning failure.

It is preferable that the scale release agent has a high affinity with diamond-like carbon, polytetrafluoroethylene, or polyvinyl chloride, which is a constituent of the surface of the location contacted by the geothermal fluid. Examples of the scale release agent include 2-(furan-2 ylmethyldisulfanylmethyl) furan, ascorbic acid, nicotinic acid, and the like. Among these, the scale release agent preferably contains 2-(furan-2 ylmethyldisulfanylmethyl) furan. Thus, the bonding force between silica scale and the surface of the location in the geothermal power plant 100 contacted by the geothermal fluid can be further reduced.

Next, an experimental example of the method for removing scale in the geothermal power plant 100 will be described. One material piece made of 13% chromium steel (13% Cr steel), three material pieces (DLC-1, DLC-2, and DLC-3) each including a diamond-like carbon (DLC) layer having a thickness of 1 mm on a surface of 13% chromium steel, one material piece made of polyvinyl chloride (PVC), and one material piece made of polytetrafluoroethylene (PTFE) were prepared.

These material pieces had the same size. Each material piece was installed in the retention tank of the geothermal power plant, taken out after 107 days (2, 675 hours) passed, and cleaned with ultrasonic waves. Then, the amount of silica scale adhesion on each material piece was evaluated.

The amount of silica scale adhesion was evaluated by subjecting five randomly selected points on a surface of each material piece to elemental analysis by Energy Dispersive X-ray spectroscopy (EDX) with a Scanning Electron Microscope (SEM), and calculating the average value of the five points. The amount of silica scale adhesion on each material piece was standardized and compared, treating the obtained amount of silica scale adhesion on the material piece made of 13% Cr steel as 100%.

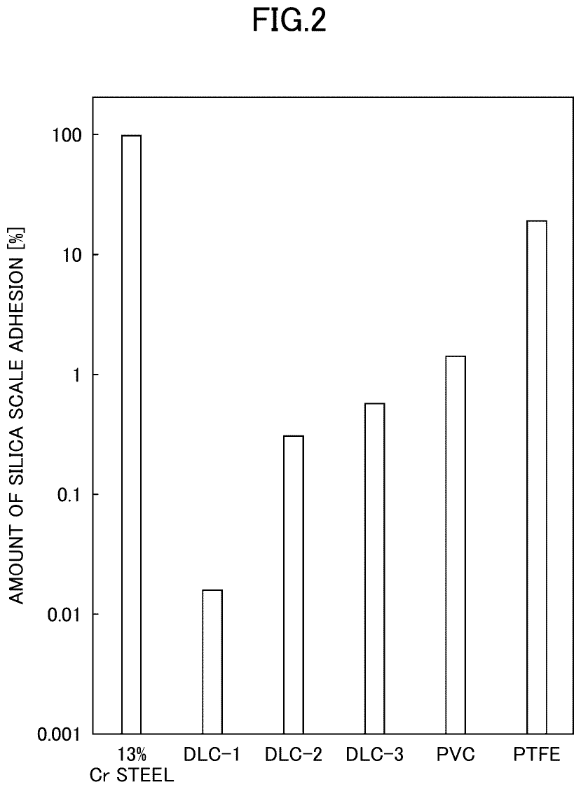

FIG. 2 is a graph illustrating the amount of silica scale adhesion on each material piece. The amount of silica scale adhesion on the vertical axis is expressed in logarithmic form. As illustrated in FIG. 2, it was confirmed that the amount of silica scale adhesion on DLC-1, DLC-2, DLC-3, PVC, and PTFE was smaller than that on 13% Cr steel, and that the bonding force between the surface of these material pieces and the silica scale was smaller. In particular, it was confirmed that the amount of silica scale adhesion on

DLC and PVC was much smaller than that on 13% Cr steel, and that the bonding force between the surface of these material pieces and the silica scale was much smaller.

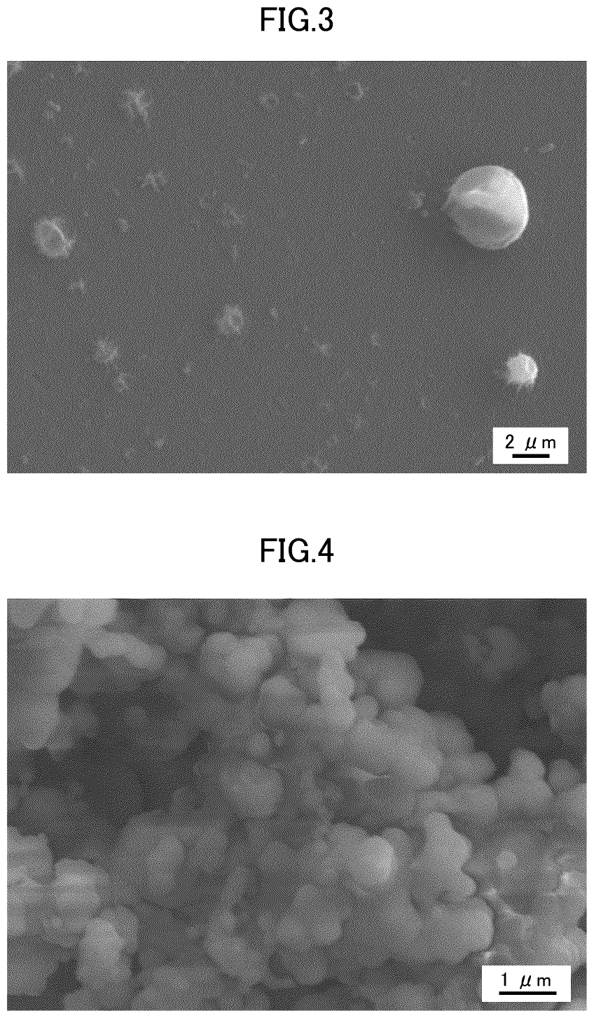

The surfaces of the ultrasonically cleaned material pieces made of 13% Cr steel and PVC were observed using a Scanning Electron Microscope (SEM). FIG. 3 is a SEM observation image illustrating the surface of the material piece made of PVC, and FIG. 4 is a SEM observation image illustrating the surface of the material piece made of 13% Cr steel. FIG. 3 is an image observed at a magnification of ×3,630, and FIG. 4 is an image observed at a magnification of ×11,150. As illustrated in FIGS. 3 and 4, it was also confirmed from the SEM observation images that the amount of silica scale adhesion on PVC was much smaller and the bonding force between the surface of the material piece made of PVC and the silica scale was much smaller than those of 13% chromium steel.

Although the embodiments have been described above, the above embodiments are presented as examples, and the present invention is not limited by the above embodiments. The above embodiments may be embodied in various other forms, and various combinations, omissions, substitutions, modifications, and the like are applicable without departing from the spirit of the invention. These embodiments and modifications thereof are included in the scope and spirit of the invention, and also included in the scope of the invention described in the claims and equivalents thereof as well.

What is claimed is:

1. A method for removing scale that is precipitated from geothermal fluid containing dissolved silica and becomes adherent in a geothermal power plant including: a water supply pump configured to pump the geothermal fluid from a production well; a gas-water separator configured to separate the geothermal fluid into geothermal water and geothermal steam; and a turbine configured to rotate by being supplied with the geothermal steam separated by the gas-water separator, with the water supply pump, the gas-water separator, and the turbine being situated in order from an upstream side of the geothermal fluid, the method comprising:
forming a surface of a location in the geothermal power plant, the location being contacted by the geothermal fluid, from diamond-like carbon in a first region extending from the production well to the turbine;
forming at least the surface of the location in the geothermal power plant from at least one selected from diamond-like carbon, polytetrafluoroethylene, and polyvinyl chloride in a region other than the first region; and
injecting a scale removing liquid into a flow path including the surface of the location.

2. The method for removing the scale in the geothermal power plant according to claim 1,
wherein the scale removing liquid is an acid or an alkali.

3. The method for removing the scale in the geothermal power plant according to claim 2,
wherein the scale removing liquid contains at least one selected from hydrochloric acid, sulfuric acid, hydroxides, carbonate compounds, hydrogen carbonate compounds, and salts thereof.

4. The method for removing the scale in the geothermal power plant according to claim 1,
wherein in a case where the geothermal fluid is geothermal steam, the scale removing liquid is spray-fed into the geothermal steam and mixed with the geothermal steam at the location contacted by the geothermal steam.

5. The method for removing the scale in the geothermal power plant according to claim 1,
wherein in a case where the geothermal fluid is geothermal water, the scale removing liquid is supplied into the geothermal water and mixed with the geothermal water at the location contacted by the geothermal water.

6. The method for removing the scale in the geothermal power plant according to claim 5,
wherein the scale removed by the scale removing liquid is collected on a downstream side of a position at which the scale removing liquid is supplied to the geothermal fluid.

7. The method for removing the scale in the geothermal power plant according to claim 6,
wherein a supply flow rate or a concentration of the scale removing liquid is controlled in accordance with a mass of the scale collected.

8. The method for removing the scale in the geothermal power plant according to claim 1,
wherein while the geothermal power plant is operating, the scale removing liquid is supplied to the geothermal fluid flowing through the flow path, and
while the geothermal power plant is stopped, the flow path is left to stand still while being filled with the scale removing liquid or geothermal water mixed with the scale removing liquid.

9. The method for removing the scale in the geothermal power plant according to claim 4,
wherein the geothermal power plant includes:
a condenser configured to condense the geothermal steam discharged from the turbine;
a cooling tower configured to cool condensed water resulting from condensation by the condenser; and
a retention tank situated on the flow path through which the geothermal water separated by the gas-water separator flows, and
while the geothermal power plant is operating, the scale removing liquid is injected into at least one flow path among the flow path between the production well and the water supply pump, the flow path between the gas-water separator and the turbine, the flow path between the condenser and the cooling tower, and the flow path between the gas-water separator and the retention tank.

10. The method for removing the scale in the geothermal power plant according to claim 9,
wherein the scale is collected in the flow path between the gas-water separator and the retention tank.

11. The method for removing the scale in the geothermal power plant according to claim 10,
wherein a scale release agent is supplied to the geothermal fluid in advance before the scale removing liquid is supplied to the geothermal fluid flowing through the flow path.

12. The method for removing the scale in the geothermal power plant according to claim 11,
wherein the scale release agent contains 2-(furan-2-ylmethyldisulfanylmethyl) furan.
